(19) United States
(12) Patent Application Publication
(10) Pub. No.: US 2003/0002591 A1
(43) Pub. Date: Jan. 2, 2003

(54) Method, device and system for managing communication transmissions

(75) Inventors: Rafael Boneh, Tel Aviv (IL); Yair Tal, Matan (IL); Uzi Ram, Givat Elah (IL); Yariv Saleternik, Tel Aviv (IL)

Correspondence Address: BANNER & WITCOFF, 1001 G STREET N W, SUITE 1100, WASHINGTON, DC, 20001, US

(73) Assignee: Gilat Satellite Networks, Ltd., Petah Tikva (IL)

(21) Appl. No.: 10/186,685

(22) Filed: Jul. 2, 2002

Related U.S. Application Data
(60) Provisional application No. 60/301,803, filed on Jul. 2, 2001.

(51) Int. Cl. H04L 27/20; H04L 27/12; H04L 27/04

(52) U.S. Cl. 375/295

(57) ABSTRACT

The present invention relates to a system, device and method for managing satellite communication transmission. Transmission management is accomplished without intervention from a central processing unit (CPU) to improve overhead. Transmission parameters from a first data buffer may be stored to configure transmission of data in a time slot without CPU intervention.

This application claims the benefit of U.S. Provisional Application No. 60/301,803, filed Jul. 2, 2001, which is incorporated herein in its entirety.

### FIELD OF THE INVENTION

The present invention relates to communications systems and, more particularly, to a method, device, and system for managing communication transmissions with higher operating efficiency and minimal intervention.

### BACKGROUND OF THE INVENTION

Spectrum efficiency has become an important issue and concern in the transmission of data messages. To accommodate increases in use of transmission networks and systems, bandwidth may be increased to accommodate the increase in traffic. In this context, management of data transmission with such increasing bandwidth needs within narrowly defined channels is difficult. These transmissions need to be maintained in narrowly defined channels and the throughput of the channel should be maximized to increase efficiency. Because each channel has a certain amount of bandwidth, there are inherent limits on the amount of information that may be transmitted at any one time. In order to maximize utilization of available bandwidth, upstream communication transmission of a data transmission terminal may involve time division multiplexing (TDM) and/or frequency division multiplexing (FDM). Using such schemes, the available bandwidth resources are more efficiently utilized and a larger number of data transmission terminals may be used in a given space segment.

In FDM, data may be transmitted over a channel that is divided into bands based on frequency. Each band may be used for a separate transmission. For example, data may be transmitted over a line of a data communication network by transmitting each call within a specified frequency channel on the line.

In TDM, the time axis is divided into time slots. By dividing each channel into several time slots, multiple communication paths may be established on each channel. Thus, a number of separate signals may be transmitted simultaneously over one communication medium. In this way, each transmission is sampled into fragments. Multiple communications are sampled and the individual samples of the different communications are interleaved and transmitted on a single line. For example, sampling may be performed for each bit (bit interleaving) or one byte (word interleaving). Sampling may be accomplished with a time division multiplexer that connects bit streams sampled at regular intervals from multiple channels. As an example, a communication channel may be logically divided into multiple channels or time slots. A first device may transmit during the first time slot, a second device during the second time slot and a third device during the third time slot. This pattern may be repeated by interleaving samples from each of the transmitting devices by sampling each transmission, transmitting them separately (i.e., interleaved with other transmissions) and reconstructing the individual transmissions at the receiver end. The result is lower costs and fewer necessary resources as more transmissions are handled by each channel.

Management of upstream communication in a data communication transmission is typically controlled by a central processing unit (CPU). With TDM, the size of the time slot used continues to decrease in order to provide for increased bandwidth utilization. Thus, with increased use of data communication transmission, increased bandwidth utilization becomes increasingly important necessitating smaller time slots in TDM. Data transmission is typically managed by a CPU but with increased bandwidth utilization and smaller time slots in TDM, CPU intervention becomes excessive. As a result, CPU intervention with larger numbers of users per transmission segment increases which leads to increased costs.

Thus, there exists a need in the art for a method, device, and system for managing satellite communication transmission efficiently with higher operating efficiency and minimal intervention and overhead of a system controller.

### SUMMARY OF THE INVENTION

The present invention relates to a method, system and device for managing data communication that solves the problems of the prior art. Transmission parameters and transmission data are stored in data buffers in memory and loaded into a transmission system. The transmission data is arranged in data buffers and may be arranged in frames. Buffer descriptors may point to data buffers such that the system may access the contents of the data buffers and transmit the data.

In an embodiment of the present invention, the transmission parameters are obtained from a first data buffer and stored in a control unit in a data transmission terminal, for example, a satellite transmission terminal or a two-way satellite transmission terminal. The transmission parameters may configure the transmission subsystem for transmitting data to be transmitted for an upcoming time slot, with minimum CPU intervention. Data to be transmitted may be obtained from subsequent data buffers in memory and transmitted based on the stored transmission parameters. After the data is transmitted, the system may obtain transmission parameters of a next data communication transmission to configure the transmission data to be transmitted in the next time slot. The data of the next data communication transmission may be transmitted after a period of delay or guard time.

The present invention is further drawn to a system for managing data communication transmission that may comprise a direct memory access device (DMA) for obtaining or storing a buffer descriptor address, the buffer descriptor pointing to a data buffer containing data to be transmitted. The system may further comprise a control unit for storing the transmission parameters of a data transmission of an upcoming time slot and a memory comprising a data buffer that may store the data to be transmitted.

The present invention is further drawn to a device for managing data communication transmission, for example satellite data communication transmission or two-way satellite data communication transmission, that may comprise a transmission subsystem and a central processing unit (CPU). The device enables transmission of data via a satellite communication transmission with no CPU intervention and reduced overhead. Communication may also be accomplished via non-satellite, time division multiplex applications such as cellular networks or “star” terrestrial radio communication systems, for example. The CPU may be, for example, a central processing unit (CPU) for very small aperture terminal (VSAT) applications such as a system-on-a-chip (SOC) implemented in an Application Specific Integrated Circuit (ASIC).

### BRIEF DESCRIPTION OF THE DRAWINGS

The foregoing summary and a better understanding of the present invention will become apparent from the following detailed description of representative embodiments and the claims when read in connection with the accompanying drawings, all forming a part of the disclosure of this invention. While the foregoing summary and following written disclosure focus on disclosing representative embodiments of this invention, it should be clearly understood that the same is by way of illustration and example only and the invention is not limited thereto. The spirit and scope of the present invention are limited only by the terms of the appended claims.

FIG. 1 illustrates an exemplary system for implementing the invention.

FIG. 2 illustrates an exemplary System-On-a-Chip (SOC) type of ASIC.

FIG. 3 illustrates an exemplary embodiment utilizing a VSAT terminal architecture.

FIG. 4 illustrates an exemplary arrangement of data buffers and buffer descriptors (BDs) stored in the memory of a satellite data terminal.

FIG. 5 illustrates an exemplary transmission system.

FIG. 6 illustrates an exemplary method of satellite communication transmission of the present invention.

### DETAILED DESCRIPTION OF THE INVENTION

Before beginning a detailed description of the invention, it should be noted that, when appropriate, like reference numerals and characters may be used to designate identical, corresponding or similar components in differing figure drawings. Further, in the detailed description to follow, example embodiments and values may be given, although the present invention is not limited thereto.

The present invention relates to a method, device, and system for managing data communication transmissions. The invention may be used in any communication system configuration. For example, the invention may be implemented in a two-way satellite communication system. The satellite communication system may be implemented at a system-on-chip level or at a board level, for example. Alternatively, the invention may be applied to non-satellite systems such as cellular networks, time division multiplexing (TDM) applications, “star” terrestrial radio communication system, etc. As an example, transmission may be from a two-way satellite data terminal to a satellite hub. Typically, with an increase in bandwidth usage, larger numbers of users may be accommodated in a given space. However, increases in bandwidth usage may require a decrease in the length of the time slot. This in turn increases intervention from a system controller, such as a CPU. In the present invention, the need for intervention from the system controller or the CPU is reduced or eliminated.

It is to be understood that the invention is not limited in its application to the details of construction, arrangement, composition of the components, and order or sequence of steps of operation or implementation, set forth in the following description, drawings, or examples. The invention is capable of other embodiments or of being practiced or carried out in various ways. Also, it is to be understood that the phraseology and terminology employed herein are for the purpose of description and should not be regarded as limiting.

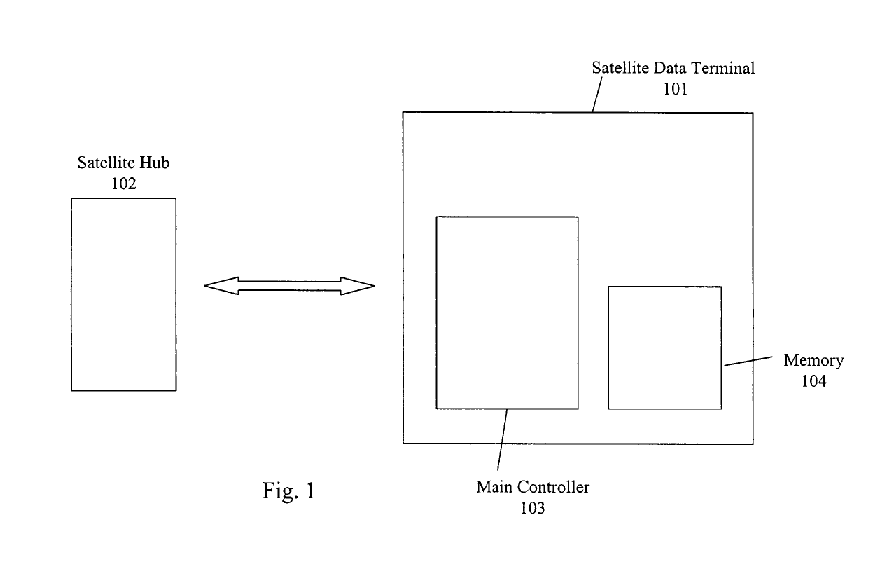

FIG. 1 illustrates one system for implementing the invention. FIG. 1 illustrates the present invention implemented on a two-way satellite communication system. Two-way satellite data terminal 101 may communicate with a satellite hub 102 with minimal intervention and overhead required by a main system controller 103. The satellite data terminal may contain a memory 104 for storing data. For example, the memory in the satellite data terminal 101 may store buffer descriptors (not shown) described below. The reduced intervention by the main system controller 103 results in improved efficiency of the system. The main system controller 103 may be any device for controlling the system such as, but not limited to, a central processing unit (CPU) for very small aperture terminal (VSAT) applications. Examples include a system-on-a-chip (SOC) implemented in an Application Specific Integrated Circuit (ASIC).

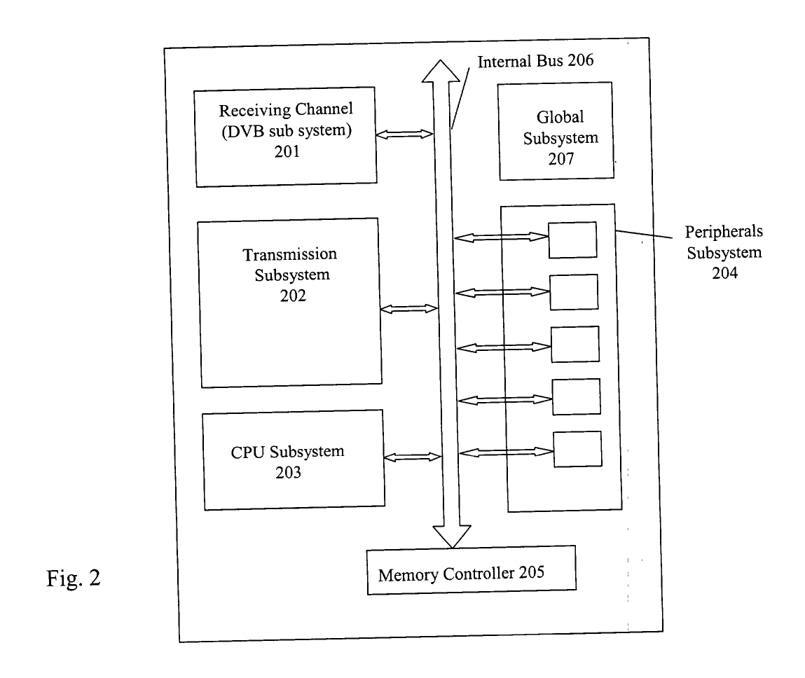

FIG. 2 illustrates a System-On-a-Chip (SOC) type of ASIC. In a highly integrated System-On-a-Chip (SOC) type of ASIC, the device may be logically divided into four sections or sub-systems. The device may comprise a receiving channel (DVB sub-system) 201, a transmission subsystem 202, a CPU subsystem 203; and a peripherals subsystem 204. An embedded Reduced Instruction Set Central Processing Unit (RISC CPU) may control the chip. An internal bus 206 may be connected to the RISC CPU and may serve as a main data pipeline for data transfer between the CPU and the various on-chip controllers, including back-end communication controllers, satellite front-end communication controllers or user ports. A memory controller 205 provides a data connection with the memory of the data terminal. FIG. 2 also illustrates a global subsystem 207. The global subsystem 207 commonly used in CPU environments may include housekeeping elements including timers, a reset circuit, a clock circuit, an interrupt controller or a debug circuit (not shown).

FIG. 3 illustrates an embodiment utilizing a VSAT terminal architecture. VSAT terminals are typically used for satellite-based point-to-multipoint data communications applications. A signal may be received from an outdoor unit at a tuner 306. In this example, the signal is demodulated by a demodulator 305 and received in the system controller at the receiving channel 301. The system controller further contains a CPU subsystem 303 for controlling the chip. Data flows through the internal bus 310 which may serve as a main data pipeline for data transfer between the CPU and the various on-chip controllers. Data may be processed by a transmission subsystem 302, conveyed to a Chip Lband synthesizer 307 and transmitted to an outdoor unit (not shown). A memory controller 305 provides a data connection with the memory of the data terminal. The memory may be SDRAM 311 or FLASH 312, for example. FIG. 3 also illustrates a global subsystem 313. The global subsystem 313 commonly used in CPU environments may include housekeeping elements including timers, a reset circuit, a clock circuit, an interrupt controller or a debug circuit (not shown).

Transmission data from the satellite data terminal may be stored and arranged in data buffers within the memory of the satellite data terminal. Each buffer may be identified by a buffer descriptor (BD), i.e., each buffer descriptor (BD) points to a buffer. The transmission system may comprise a direct memory access device (DMA) which may receive or store an address of a buffer descriptor (BD).

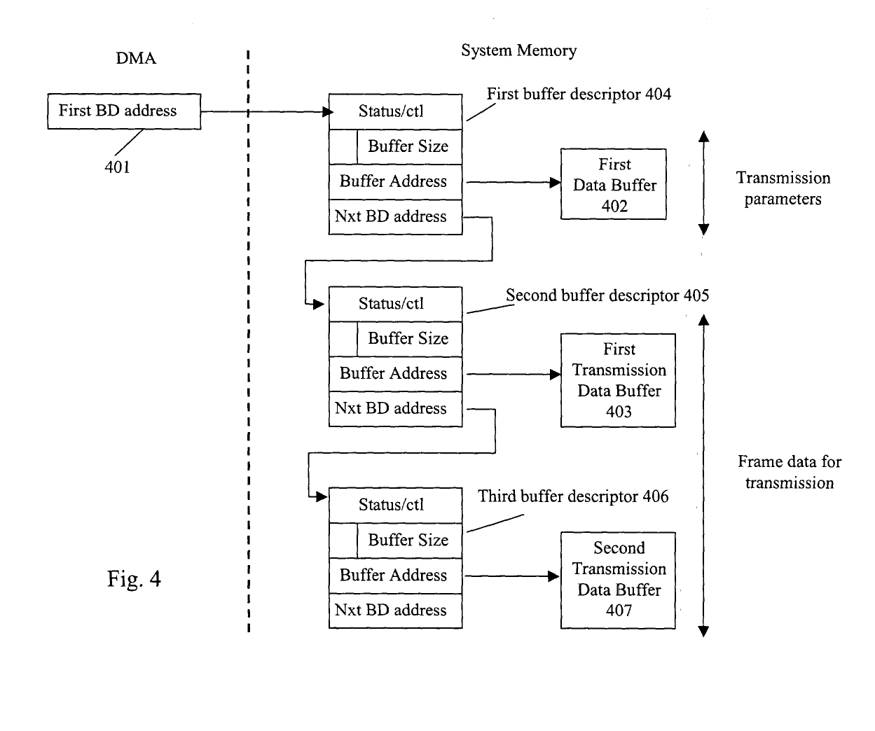

FIG. 4 illustrates an exemplary arrangement of data buffers and buffer descriptors (BDs) stored in the memory of the satellite data terminal. Transmission data such as data for a two-way communication transmission may be arranged in the data buffers that are stored in the memory of the satellite data terminal as shown. The BDs point to each data buffer and may also be stored in the memory. The BDs may be incorporated into a data structure where the buffer descriptor may point to a next element. In this way, the buffer descriptors are stored in the memory using a linked list arrangement. It should be noted that the linked list arrangement represents one example of the arrangement of data but the present invention is not so limited as any arrangement of data may be utilized as known to one of ordinary skill in the art.

As FIG. 4 illustrates, a first BD address 401 is stored in a direct memory access device (DMA) thus initializing the DMA. The BD address 401 points to BDs that point to data buffers such that after receiving the BD address, the DMA device obtains the contents of the data buffers based on the BD address 401 and the BDs and data buffers that the BD address 401 point to. The DMA device thus obtains the transmission data from the data buffers. In this example, the transmission data is contained in a first data buffer or a parameters data buffer 402. The transmission data may be divided into frames in the memory with each frame comprising at least two data buffers. FIG. 4 illustrates an exemplary predetermined arrangement of transmission data and transmission parameters in the data buffer of a message. Transmission parameters are parameters that are used to configure the transmission subsystem for transmitting data to be transmitted for an upcoming time slot, with minimal CPU intervention. Generally, the transmission parameters may define the manner of transmission of data bursts that may be transmitted by the transmission system. For example, a set of transmission parameters may be associated for each transmission burst. Examples of transmission parameters include a time slot number identifying the time slot in which the data burst is transmitted, transmit frequency, forward error correction code rate, type of forward error correction code or burst length.

According to the first BD address stored in the direct memory access (DMA) device, the DMA accesses the first buffer containing the transmission parameters through a first buffer descriptor 404. The first BD 404 may point to a next buffer descriptor address or a second buffer descriptor 405 in this example. The second BD 405 points to a data buffer or a first transmission data buffer 403 that may contain transmission data. The second BD 405 may also point to a third BD 406, the third BD 406 pointing to a second transmission data buffer 407. Although FIG. 4 illustrates a first BD 404, a second BD 405, a third BD 406, a parameters data buffer or first data buffer 402, a first transmission data buffer 403 and a second transmission data buffer 407, it is noted that the system may contain any number of data buffers or BDs depending on the data to be transmitted and the requirements or needs of the system. For example, as illustrated in the example of FIG. 4, the transmission data may be arranged in frames with the data in the first transmission data buffer 403 and the data in the second data buffer 407 being arranged within a frame of data for transmission.

FIG. 5 illustrates an exemplary transmission system. In this example, the DMA 501 loads the transmission parameters obtained from the system memory, for example, into a control unit 502 of the transmission system. The transmission data may be processed within the transmission system or subsystem. For example, forward error correction code may be inserted by a forward error correction unit 506 and the data may be arranged into frames by a data framer 505. The transmission data may be further converted by a digital-to-analog converter 504 and transmitted to a radio frequency (RF) synthesizer 503. The RF synthesizer 503 generates an RF frequency that enables a burst transmission at a desired frequency. Each data burst transmission is transmitted at a corresponding transmission frequency, the transmission frequency being one of the transmission parameters that define how data bursts are transmitted by the transmission subsystem. Each data burst may be transmitted at a different transmission frequency. Thus, in this example, the transmission subsystem may retrieve the transmission frequency from the data buffer and convey the transmission frequency to the RF synthesizer 503. Based on the transmission frequency parameter, the RF synthesizer 503 generates an RF frequency and enables a burst transmission at this frequency. The RF synthesizer may be controlled by a controller 507.

The transmission system may perform a programming sequence after the last message is transmitted to begin a next communication transmission. The programming sequence may include, for example, programming the radio frequency (RF) synthesizer 503 through a serial protocol. The programming sequence may comprise signals generated by the transmission system and sent to the RF synthesizer 503. The RF synthesizer 503 receives the programming sequence and programs a new frequency for the next data burst. An example of a serial protocol that may be used to program the radio frequency (RF) synthesizer 503 includes an I2C or a three wire serial interface including data, clock and strobe lines. Following the completion of the programming sequence, the transmission system reconfigures its internal units for the transmission of the next data transmission.

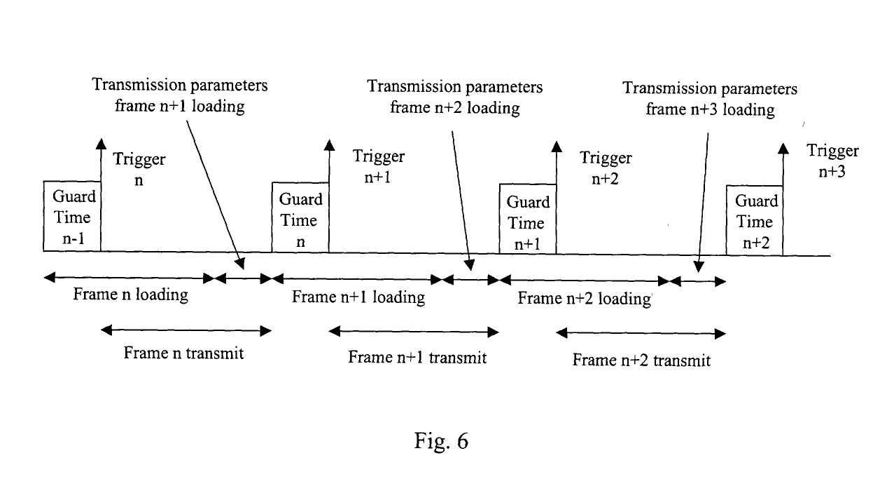

FIG. 6 illustrates an exemplary method of satellite communication transmission of the present invention. In this example, the transmission proceeds in a pipeline or sequential manner. The DMA device 501 obtains the last buffer of the previous data transmission, then obtains the first buffer of the next data transmission message. The first buffer of the next data transmission message includes the transmission parameters associated with the next data transmission message and may be used to configure the data transmission units in the upcoming time slot. The “guard time” as illustrated in FIG. 6 describes the time gap between the conclusion of one data transmission and the beginning of a second data transmission. The second data transmission may begin at a trigger signal, for example. Thus, the guard time refers to the difference between the length of each time slot period and the actual time taken to transmit a frame of data. If the guard time is zero, optimal time slot usage is maximized as all time is effectively utilized. However, if guard time is zero, there may be time slot overlap due to inherent inaccuracies in satellite communication systems. Thus a tradeoff exists regarding the optimal length of the guard time with the optimal length of time depending on the requirements of the system. Therefore, ideally, the guard time would be a finite, non-zero but minimal value.

FIG. 6 further illustrates a first period wherein a first frame (labeled “frame n”) is loading and is being transmitted. Transmission of “frame n” is offset from loading of “frame n” such that loading of “frame n” is completed prior to the completion of the transmission of “frame n” by a “guard time.” After loading of “frame n” is completed, transmission parameters of the next frame (labeled “frame n+1”) are obtained. The transmission parameters of “frame n+1” may be used to configure the data transmission units of the “frame n+1” time slot. After “frame n” loading is completed but before the beginning of the next time slot, the system begins loading “frame n+1”. In this example, transmission of “frame n+1” begins after the guard time has elapsed and may be responsive to a trigger signal. Thus, the guard time minimizes the problems associated with small inherent timing problems that may result in overlap of adjacent time slots. After the guard time elapses, the next time slot begins and “frame n+1” is transmitted in the next time slot. In this example, data transmission is performed in a pipeline or sequential manner including frame n+2 as illustrated in FIG. 6. FIG. 6 is for illustration purposes only and the present invention is not so limited. For example, any number of frames may be transmitted.

Although the present invention has been described with reference to illustrative embodiments thereof, it should be understood that numerous other modifications and embodiments can be devised by those skilled in the art that will fall within the scope and spirit of the principles of the invention. More particularly, reasonable variations and modifications are possible in the component parts and/or arrangements of the subject combination arrangement within the scope of the foregoing disclosure, the drawings and the appended claims without department from the spirit of the invention. In addition to variations and modifications in the component parts and/or arrangements, alternative uses will also be apparent to those skilled in the art.

What is claimed is:

1. A method for managing data communication transmission comprising:
storing transmission parameters of a first data transmission;
loading data to be transmitted associated with said transmission parameters;
transmitting said data to be transmitted based on said transmission parameters.

2. The method of claim 1 further comprising the step of obtaining transmission parameters of a second data transmission during transmission of said data to be transmitted.

3. The method of claim 2 further comprising the step of loading second data to be transmitted associated with said transmission parameters of the second data transmission.

4. The method of claim 3 further comprising the step of transmitting said second data to be transmitted after a delay.

5. The method of claim 4 wherein said delay comprises a guard time, said guard time being measured from completion of said first data transmission and the commencement of said second data transmission.

6. The method of claim 5 wherein data to be transmitted is transmitted in response to a trigger signal.

7. The method of claim 1 wherein data to be transmitted is stored in data buffers.

8. The method of claim 7 wherein said data to be transmitted is divided into frames, each frame comprising at least two data buffers.

9. The method of claim 1 wherein data to be transmitted for an upcoming time slot is configured based on said transmission parameters.

10. The method of claim 9 wherein said transmission parameters are selected from the group consisting of a time slot number, a transmission frequency, a forward error correction code rate, a type of forward error correction code and a burst length.

11. The method of claim 1 wherein the data communication transmission comprises a two-way satellite communication transmission.

12. A system for managing data communication transmission comprising:
a direct memory access device (DMA);
a control unit; and
a memory comprising at least one data buffer,
said direct memory access device (DMA) obtaining transmission parameters associated with data to be transmitted and loading said transmission parameters into said control unit.

13. The system of claim 12 wherein said memory comprises buffer descriptors, each of said buffer descriptor pointing to one of said at least one data buffer.

14. The system of claim 13 wherein the buffer descriptors are arranged in a linked list arrangement.

15. The system of claim 12 wherein said at least one data buffer comprises data to be transmitted.

16. The system of claim 15 wherein said data to be transmitted is divided into frames.

17. The system of claim 16 wherein each of said frame comprises at least two data buffers.

18. The system of claim 12 further comprising a radio frequency (RF) synthesizer for generating a frequency for data transmission.

19. The system of claim 12 wherein said transmission parameters are selected from the group consisting of a time slot number, a transmission frequency, a forward error correction code rate, a type of forward error correction code and a burst length.

20. The method of claim 12 wherein the data communication transmission comprises a two-way satellite communication transmission.

21. A device for managing data communication transmission comprising:
a receiving channel;
a transmitting channel;
a CPU sub-system; and
a peripherals sub-system,
said transmitting channel comprising a direct memory access device (DMA), said DMA obtaining transmission parameters associated with data to be transmitted and loading said transmission parameters into a control unit.

22. The device of claim 21 further comprising a memory wherein said memory comprises buffer descriptors, each of said buffer descriptor pointing to at least one data buffer.

23. The device of claim 22 wherein the buffer descriptors are arranged in a linked list arrangement.

24. The device of claim 22 wherein said at least one data buffer comprises data to be transmitted.

25. The device of claim 24 wherein said data to be transmitted is divided into frames.

26. The device of claim 25 wherein each of said frame comprises at least two data buffers.

27. The device of claim 21 further comprising a radio frequency (RF) synthesizer for generating a frequency for data transmission.

28. The device of claim 21 wherein said transmission parameters are selected from the group consisting of a time slot number, a transmission frequency, a forward error correction code rate, a type of forward error correction code and a burst length.

29. The method of claim 21 wherein the data communication transmission comprises a two-way satellite communication transmission.
